(19) United States
(12) Patent Application Publication
(10) Pub. No.: US 2007/0028856 A1
(43) Pub. Date: Feb. 8, 2007

(54) Functional dog muzzle strap structure

(76) Inventor: Hung-Chun Ma, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/198,269

(22) Filed: Aug. 8, 2005

(51) Int. Cl. A01K 15/04

(52) U.S. Cl. 119/831

(57) ABSTRACT

The present invention provides a functional dog muzzle strap structure mainly including movable loop fasteners on a single strap, mutual disposition of which forms a dog muzzle strap having adjustable muzzle functionality. A dog collar function is further derived from the dog muzzle strap, thereby forming a dual effective and dual functional structure that provides a value added use to the dog muzzle strap. The dog collar derived from the muzzle strap has functionality to adjust and attain optimum degree of tightness from movements of the dog itself, thereby completely eliminating restriction to use on dogs having a mouth and nose of certain dimensions, and enabling the dog muzzle strap to be extensively used on all types of different sized dogs, entirely overcoming drawbacks known to exist in conventional dog muzzles.

### BACKGROUND OF THE INVENTION

(a) Field of the Invention

The present invention relates to a functional dog muzzle strap structure, and more particularly to a muzzle strap structure that is not confined to use on dogs of certain size or on dogs having a nose and mouth portion of certain dimensions. Moreover, the present invention has functionality to adjust degree of tightness from movements of the dog itself. Furthermore, a dog collar derived from the integral structure of the muzzle strap provides added value to the present invention, thereby achieving effective use of a single strap as a dual functional muzzle strap and collar.

(b) Description of the Prior Art

FIG. 1 shows a conventional dog muzzle (A1) fabricated from a hard net, which is placed over the mouth and nose of a dog, and then a pull cord (A2) is used to secure the muzzle (A1) round the neck of the dog. When placing the muzzle (A1) over the mouth and nose of a dog, particular attention must be paid that an upper cutaway edge of the dog muzzle (A1) pushes against the bridge of the nose of the dog, and that a bottom edge of an opening of the dog muzzle (A1) extends close to the throat portion of the dog, thereby ensuring that the entire mouth and nose portion of the dog is enclosed within the dog muzzle (A1), thus inhibiting the dog from opening its mouth and attacking people or indiscriminately biting objects. The various inherent shortcomings in the conventional dog muzzle (A1) can be known from the aforementioned, and are listed and further expounded upon below:

1. Because the conventional dog muzzle (A1) must be manufactured in different sized hard nets, apart from requiring businesses to stockpile a multitude of the different sized muzzles (A1), moreover, common use of the conventional dog muzzle (A1 is extremely limited. In other words, the dog muzzle (A1) suitable for a large dog is not appropriate for a small dog; likewise, the dog muzzle (A1) suitable for a small dog is not appropriate for a large dog. Furthermore, because shape, size and length of the mouth and nose portion of each dog vary, thus, the conventional dog muzzle (A1) is inappropriate for common use. Hence, the dog muzzle (A1) of particularly dimensions must be purchased specific to each dog, which apart from causing storage problems for dog owners, it also results in the drawback of additional purchase expenses.

2. Because the conventional dog muzzle (A1) adopts a covering and arresting method, after placing and tightening the dog muzzle (A1) over the mouth and nose of the dog, the dog is unable to open its mouth, which imperceptibly results in the dog being subjected to an extremely oppressive feeling and visual obstruction that is not only a great discomfort to the dog, but is also a great hindrance to dogs that need to stick out their tongue to dissipate heat when overheated. Hence, apart from the problem of inhumane and inappropriate treatment of dogs, because the dog is unable to adapt to and accept wearing the conventional muzzle (A1), the dog becomes even more short-tempered (similar to an ill-tempered large-sized dog) and frequently claws the covering portion of the dog muzzle (A1), scratching himself severely as a consequence.

3. Extending from that described in point 2 above, because of a bad experience wearing the muzzle (A1), as soon as the dog sees the muzzle (A1), it inevitably reacts aggressively and tears at the muzzle (A1) with its mouth. However, the muzzle (A1) is unable to withstand the aggressive biting of the dog, which results in an extremely high rate of damage to the muzzle (A1) and continuous waste in purchase expenses for the owner.

4. Because the conventional muzzle (A1) is completely independent of the dog collar, if a dog collar is required, then it must be purchased separately. Moreover, because of the possibility of the dog muzzle (A1) falling off, thus a shortcoming in safety is a major drawback of the conventional muzzle (A1). 5. Because the conventional muzzle (A1) is fabricated from a hard net and is worn by covering the mouth and nose of the dog, after placing the muzzle (A1) over the mouth and nose of the dog, its external form is extremely inelegant, and creates associations of a pig nose, which further affects the entire external esteem and carriage of the dog.

### SUMMARY OF THE INVENTION

Accordingly, a primary objective of the present invention is to provide a functional dog muzzle strap structure, and more particularly to providing a redesigned functional dog muzzle strap structure that not only completely breaks away from the long existent set pattern of conventional dog muzzles, but is also simpler and faster to manipulate, more convenient to use and safer, thereby making the present invention more ideal and faultless.

Hence, compared to prior art, the present invention can be acknowledged as providing innovation and advancement. Advantageous effectiveness and derived functionalities of the present invention are described below:

1. Structural design of the functional muzzle strap effectively enables it to be extensively used on dogs of different size and different shaped mouths, thereby providing the muzzle strap with optimum common use characteristics.

2. Structural design of the functional muzzle strap effectively derives a neck strap function therefrom, which provides added value to the present invention. Moreover, the neck strap function also has extensive use on all types of different sized dogs, and similarly provides the muzzle strap with optimum common use characteristics.

3. The single strap of the present invention is all that is used to derive a dual functional design for a muzzle strap and neck strap that is able to effectively use a connecting relation between the two to achieve a function that enables the dog to adjust the strap by itself, thereby achieving a dual functional design that completely meets the factors required for safety and comfort.

4. Extending from that described in point 3 above, because the muzzle strap of the present invention is not bound tight on the mouth of the dog but retains an appropriate clearance in accord with degree of tightness of the neck strap, thus, the dog is able to open its mouth slightly. Hence, the dog can freely stick out its tongue to dissipate heat when overheated, which provides the present invention with the advantage of humanely treating dogs.

5. Extending from that described in point 3 above, because the present invention only uses a single strap, thus, its serviceable life is far superior than that of conventional dog muzzles. Moreover, the present invention is able to withstand biting and tearing from the dog, and has advantages of being extremely durable and having a long serviceable life.

6. Extending from that described in point 3 above, the neck strap function of the present invention enables a dog lead to be fastened thereto, thereby forming an optimum structural design for use when waking the dog outside, and provides the present invention with functional advantages including high added value, practicability, ease of use, and so on.

7. A loop method is used to loop the muzzle strap of the present invention round the mouth and nose portion of a dog, which overcomes the shortcoming of conventional dog muzzles that bestows an inelegant external esteem and carriage to the dog.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view of a conventional muzzle for exclusive use on a dog.

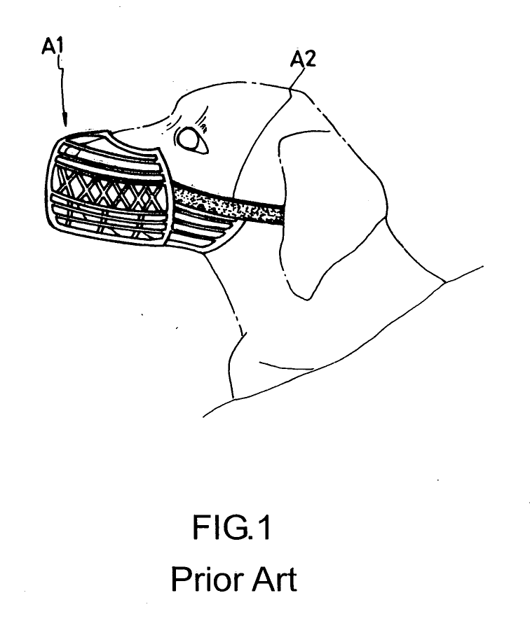

FIG. 2 shows an elevational schematic view depicting an outward appearance of the present invention.

FIG. 3 shows a schematic planar view and manipulation of an embodiment according to the present invention.

FIG. 4 shows an elevational schematic view depicting a loop formed prior to binding round the mouth and nose of a dog according to the present invention.

FIG. 5 shows a schematic view of the embodiment of the present invention after placing on a dog.

### DETAILED DESCRIPTION OF THE PREFERRED EMBODIMENTS

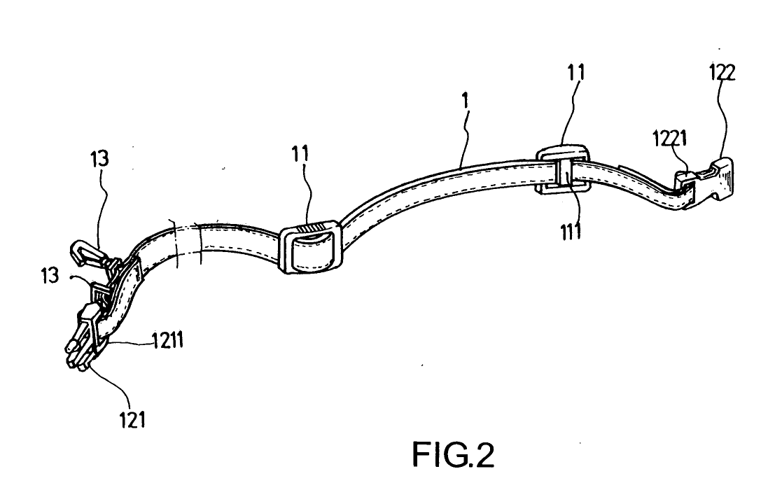

Referring to FIG. 2, which shows an outward appearance of the present invention that is structured to comprise a strap (1), on which are disposed movable loop fasteners (11), rapid connecter fasteners (12) and traction fasteners (13), wherein the movable loop fasteners (11) adopt a thread through type structure, and a double-groove defined by a center stem (111) configured on each of the movable loop fasteners (11) enables segmentation of the strap (1) by using a thread-in, thread-out method to thread the strap (1) through the movable loop fasteners (11), thereby enabling slip type adjustments to be carried out within an effective length of the strap (1) using the movable loop fasteners (11). The rapid connecter fasteners (12) are respectively attached to two ends of the strap (1), wherein the rapid connecter fastener (12) at one end of the strap (1) functions as a male fastener (121), and the rapid connecter fastener (12) at the other end functions as a female fastener (122). The male fastener (121) and the female fastener (122) have functionality to rapidly snap fasten together. Regarding adjustment of the total length of the strap (1), when threading a first connecting portion (1211) of the male fastener (121) or a second connecting portion (1221) of the female fastener (122) onto and connecting to the ends of the strap (1), the total length of the strap (1) can be decided upon and adjusted to an optimum length appropriate to fit the needs of each dog. The traction fastener (13) is attached to the strap (1), and has particular function that enables peripheral articles designed for exclusive use on dogs to be fastened thereto, such as a dog lead, ornamental bell, and so on. Accordingly, more than one traction fastener (13) can be attached to the strap (1), thereby enabling various peripheral articles designed exclusively for dogs to be attached to the strap (1) at the same time.

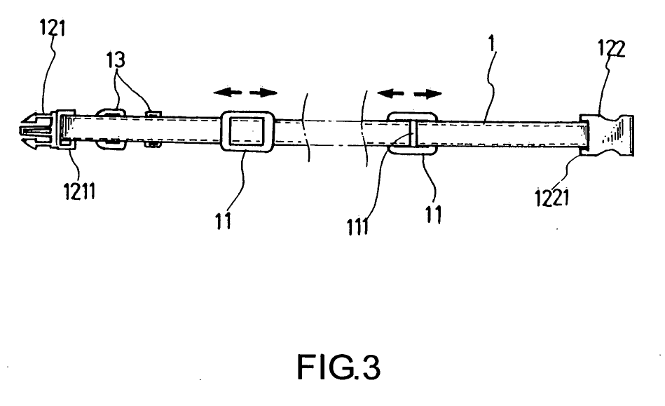

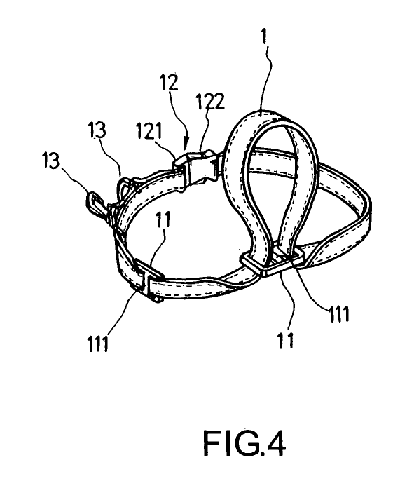

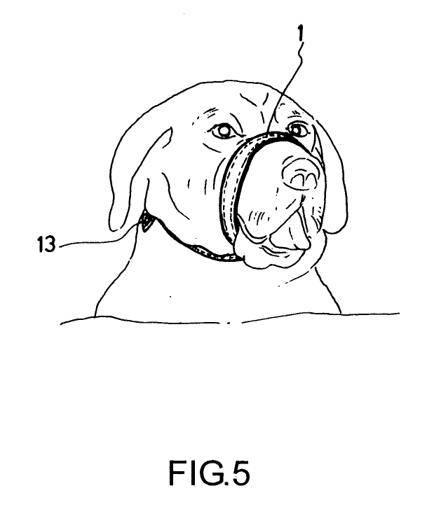

Referring to FIG. 3, the movable loop fasteners (11) can be slid left and right on the strap (1) to position the movable loop fasteners at a correct location. Furthermore, a plurality of the movable loop fasteners (11) can be attached to the strap (1) for spare use. Referring to FIG. 4, which shows the present invention ready to be placed over the mouth and nose portion of a dog, which is accomplished by first threading and pulling the strap (1) through the movable loop fasteners (11) so that the strap (1) assumes a loop form. The loop-formed strap (1) portion is then placed round the mouth and nose portion of the dog, whereafter the strap (1) at two ends of the loop-formed strap (1) portion are pulled to bring together the loop-formed strap (1) portion to an optimum degree of tightness, and the movable loop fastener (11) is used to fix position thereat. The strap (1) portions extending from two sides of the loop-formed strap (1) portion can then be placed round the back of the neck of the dog, and the male and female rapid connecter fasteners (121, 122) at the two ends of the strap (1) are quickly fastened together, thereby muzzling the dog using the one strap (1) of the present invention that simultaneously forms a dual functional muzzle strap and collar, as depicted in FIG. 5.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A functional dog muzzle strap structure, comprising a single strap structural form, whereon is respectively disposed movable loop fasteners, rapid connecter fasteners and traction fasteners, and characterized in that:
the strap threads over a center stem configured on each of the movable loop fasteners, thereby enabling the strap to thread through the movable loop fasteners by means of a thread-in, thread-out method over the center stem; two ends of the strap respectively thread onto and connect to a connecter portion of a male fastener and a female fastener, which apart from providing functionality to adjust total length of the strap, moreover, the male fastener and the female fastener also enables a rapid fastening function therebetween;
furthermore, the traction fasteners are fixedly attached to the strap, and enable peripheral articles designed for exclusive use on dogs to be fastened thereto.

2. The functional dog muzzle strap structure according to claim 1, wherein more than one of the movable loop fasteners can be disposed on the strap for spare use.

3. The functional dog muzzle strap structure according to claim 1, wherein more than one of the traction fasteners can be disposed on the strap, thereby enabling more than one peripheral article designed for exclusive use on dogs to be fastened thereto.
